(19) United States
(12) Patent Application Publication
(10) Pub. No.: US 2026/0242694 A1
(43) Pub. Date: Aug. 20, 2026

(54) COMPOSITION

(71) Applicant: Conopco, Inc., d/b/a UNILEVER, Englewood Cliffs, NJ (US)

(72) Inventors: Rafael Tassiro CACHIBA, Itapira (BR); Alejandro Maria CALDERON, Campinas (BR); Isabella Victoria MONTUORI, São Paulo (BR); Alyn James PARRY, Neston, Cheshire (GB)

(21) Appl. No.: 18/993,130

(22) PCT Filed: Jun. 1, 2023
(86) PCT No.: PCT/EP2023/064673

§ 371 Date: Jan. 10, 2025

(30) Foreign Application Priority Data
Jul. 13, 2022 (EP) 22184603.3

(51) Int. Cl. C11D 1/66; C11D 3/04; C11D 3/20; C11D 3/24; C11D 3/34; C11D 3/40

(52) U.S. Cl. CPC C11D 1/66; C11D 3/044; C11D 3/2065; C11D 3/2068; C11D 3/2093; C11D 3/245; C11D 3/3409; C11D 3/3418; C11D 3/40; C11D 2111/12

(57) ABSTRACT

A concentrated laundry composition premix which is dilutable in water to form a laundry liquid composition, said premix comprising at least 10% wt. water, from 5 to 70% wt. surfactant, from 2 to 15% wt. hydrotrope, from 2 to 15% wt. phenoxyethanol and wherein the total hydrotrope and phenoxyethanol is at least 10% wt. of the premix.

The present invention relates to improves dilutable compositions.

WO 2017/075681 (Oxiteno) discloses a new thickener composition comprising a mixture of one or more alkoxylated polyol esters, one or more ethoxylated sorbitan esters and glycerol, used to increase the viscosity of cosmetic skin and hair cleansing products and of surface and fabric cleaners, as well as to make these products easier to formulate. The thickener composition described is compatible with a great variety of formulations of cosmetic skin and hair cleansing products and of surface and fabric cleaners comprising one or more surfactants, co-surfactants, solvents, fragrances, emulsifiers, preservatives, salts, pigments and/or colouring agents, besides other inert compounds with regard to the end performance, this composition being capable of increasing the viscosity thereof in a stable a measurable manner.

EP-A-1 367 118 (Unilever) discloses a process for preparing a water-soluble container which comprises: a) thermoforming a first poly(vinyl alcohol) film having a water content of less than 5 wt percent to produce a pocket; b) filling the pocket with a composition; c) placing a second film on top of the filled pocket; and d) sealing the first film and second film together.

WO 2013/043841 (Sun) discloses liquid cleaning compositions useful in cold water and hard water laundry applications, and methods for making and using such compositions. The compositions of the invention use surfactants or surfactant blends, such as a-sulfofatty acid esters or mixtures thereof (optionally along with one or more additional components), that have increased solubility/stability at cold temperatures, at higher-than-usual concentrations, and/or in hard water, with the composition remaining as a clear liquid. In certain embodiments, the compositions of the invention may be provided in the form of a unit dose, for example in a water-soluble pack or pouch. In use, the compositions of the invention result in an enhanced detergency along with a reduced amount of residue remaining in the machine, on laundered garments or cleaned dishware or hard surfaces, and on the body in personal care settings, and demonstrate a longer shelf-life, particularly when stored or used in colder temperatures.

WO 2016/061439 (Encapsys) discloses high strength, high integrity microcapsules containing a hydrophobic core material wherein said microcapsule walls are formed of copolymers of select monomers through a multistep oil-in-water emulsification polymerization process.

WO 96/21721 (Jeyes) discloses an aqueous composition for the post-treatment of washed laundry containing 0.1 to 30 percent by weight of a water-insoluble quaternary ammonium compound, 0.1 to 50 percent by weight of a water-soluble quaternary ammonium compound, 0 to 5 percent by weight of a terpene compound, 0.1 to 20 percent by weight of a water-soluble acid, and 0.1 to 20 percent by weight of an emulsifier.

Despite the prior art there remains a need for improved products which can be diluted by the user to form a working composition. Typically, such compositions, or premixes, are purchased by the consumer and diluted in the domestic environment. This means that the composition needs to be suitable for a range of water qualities, in particular water hardnesses. Diluting such products at home means that the consumers may introduce hardness ions into the laundry product which have a material impact on the integrity of the diluted product as any introduced calcium ions may interact with neutralised fatty acid to form compounds which can under certain conditions precipitate to give a hazy/opaque visual appearance and may risk destabilising the product.

It is also a challenge to be able to provide a premix product which is dilutable and also behaviourally acceptable to the consumer. The premix must be stable, visually clear, fragranced, preserved and with appropriate rheological profile such that it performs in a manner expected, in particular as regards an appropriate foaming in use without excessive foaming during dilution by the consumer. It is also important that it is easily dissoluble in water. While opaque formulations are used, visually clear formulations are highly desirable and so having a premix which is clear before and after dilution by the consumer is especially desired.

It is further highly important that the diluted product is also visually attractive and functionally adequate.

It is thus an important challenge to get a dilute at home product which is acceptable when in pre-diluted form as well as post-diluted form, is easily diluted by the consumer, and performs as a cleaning product. By easily diluted is meant that the consumer is not required to agitate the mixture in water excessively. Too much agitation means that too much foam is generated during dilution and this reduces to potency of the mixture when used as a diluted product. A product which is solubilised in water without too much agitation is particularly sought after.

Accordingly, and in a first aspect, there is provided a concentrated laundry composition premix which is dilutable in water to form a laundry liquid composition, said premix comprising water, from 5 to 70% wt. surfactant, from 2 to 15% wt. hydrotrope, from 2 to 15% wt. phenoxyethanol and wherein the total hydrotrope and phenoxyethanol is at least 10% wt. of the premix.

The concept of ‘dilute at home product’ is becoming more popular among more environmentally aware consumers. The challenge to the formulator is to make a product which has the right physical and performance characteristics during an extra phase in the product's life cycle. Whereas previously the formulator needed to be mindful of the product as sold and the product in use they now have to consider the performance of a product which is diluted by the consumer too. This becomes more difficult when one considers the role of surfactant in such detergent formulations and the manner in which they are used after dilution in the domestic environment. High levels of surfactant without suitable foam control and the product foams too readily in the wash and cleaning in horizontal axis washing machines is reduced; not enough surfactant and product will foam appropriately for in use but also does not clean. Further, the viscosity also needs careful management as the addition of water can mean a significant change in the rheological performance of the product. Accordingly, managing these new physical performance requirements becomes vital to providing an appropriate product. Such desired performance behaviours include being easily dissoluble in domestic supplied water thereby reducing the need for aggressive shaking by the consumer and so reducing the chance of excess foam being generated. Ordinarily, these are aspects which are not under the spotlight when formulating a regular liquid product.

There is also an added challenge in that the water used to dilute the premix is not controlled. Thus, the premix must be designed such that its performance is not affected by water quality, in particular water hardness.

We have surprisingly found that lower levels of surfactant can be used to form a product which is dilutable by the consumer in a domestic setting and which is stable when in concentrated form, stable when in diluted form and also has acceptable performance when used as a liquid detergent in washing machines or in hand washing of fabrics.

By stable is meant that the product is rheologically acceptable and does not change, rheologically or in regard to phase maintenance, when the product is diluted by the consumer.

Preferably, the premix has a viscosity measured at 25° C. and at 106 s⁻¹ of from 150 to 600 mPa·s, more preferably from 250 to 500 mPa·s.

Preferably, the viscosity of the stable laundry liquid composition which is formed from a dilution of five parts water to one part premix and measured at 25° C. and at 106 s⁻¹ is from 200 to 800 mPa·s more preferably from 250 to 500 mPa·s.

The pH of the composition is strictly controlled such that the pH does not change during dilution by the consumer and also provides appropriate phase control during dilution. The pH of the premix composition is from 5 to 9 and preferably from 6.0 to 7.0.

Preferably, the premix composition comprises at least 10% wt. water.

Preferably the premix composition comprises from 5 to 13% wt. phenoxyethanol.

### Hydrotrope

The premix composition of the invention incorporates a hydrotrope. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates).

Mixtures of any of the above-described materials may also be used.

The preferred hydrotrope is monopropylene glycol.

Preferably, the premix composition comprises from 5 to 13% wt. hydrotrope.

Preferably, the total hydrotrope and phenoxyethanol is from 13 to 17% wt. of the premix.

We have surprisingly found that the level of hydrotrope can be reduced with the balance being phenoxyethanol. This can be done without any deleterious effect on the performance of the premix.

The pH may be controlled through a combination of TEA and/or fatty acid though other buffers with an appropriate pKa are also suitable.

The polyol compounds of the embodiments of this invention can be natural polyols or synthetic polyols of having at least three hydroxyl groups, and their examples are shown (but not limited to) from the following classes of compounds:

Sugar alcohols, also called polyhydric alcohol or polyalcohol with at least three hydroxyl groups, having the general formula of HOCH₂(CHOH)ₓCH₂OH.

Examples include, but not limited to, mannitol, sorbitol, galactitol, fucitol, iditol, inositol, volemitol, isomalt, maltitol, lactitol, maltotritol, maltotetraitol, and polyglycitol, disaccharides which are formed from two monosaccharide by dehydration via glycosidic linkage. Examples include but not limited to, trehalose, sucrose, lactose, maltose, etc.

Those which contain six or more hydroxyl groups,

Dextrin with a chemical structure of (C₆H₁₀O₅) n, where n is from 2 to 20, Pentaerythritol and di-pentaerythritol,

Dendrimer polyols. For examples, Bolton(R)H2004, H2003, and H₂O have 6, 12, and 16 terminal hydroxyls, respectively,

Polyglyceryls with 3 to 10 glycerin units, with six or more hydroxyl groups, and glycerol.

Preferably, the polyol is selected from polyol s with from 3 to 6 hydroxyl groups, more preferably selected from sorbitol, pentaerythritol and glycerol.

Preferably, the ethoxylated polyol ester comprises on average at least two ester units per molecule.

The ethoxylated polyol ester provides improved rheological characteristics in the context of a product which is diluted by the consumer in the domestic environment. It should be noted that this is independent of any rheological behaviour which is affected by pouring or otherwise using the diluted product. The concentrated premix is to be diluted by the user and as such it is necessary for the premix to behave rheologically appropriately.

More preferably the ethoxylated polyol ester comprises from 50 to 1000 ethoxylate units, more preferably from 200 to 700 and most preferably from 300 to 550.

More preferably the ethoxylate groups comprise from 30-150 EO, more preferably 30-80 based on the average per polyol.

Preferably, the ester comprises a fatty acid having from 10 to 22 carbons, more preferably from 14 to 20 and most preferably 18 carbons. The fatty acid may be straight chain or branched, saturated or unsaturated. The most preferred fatty acid group is a stearic acid group except where the polyol is sorbitol in which case the ester is oleic acid.

Where the polyol is sorbitol it is preferred that from 20% wt. of all fatty acid components in the ethoxylated sorbitan ester are C14-20. More preferably, from 60% of all fatty acid components in the ethoxylated sorbitan ester are C14-20 and most preferably at least 90% of all fatty acid components in the ethoxylated sorbitan ester are C14-20.

Preferably, from 60% wt. of all fatty acid components in the ethoxylated sorbitan ester are C16-18.

More preferably, from 75% of all fatty acid components in the ethoxylated sorbitan ester are C16-18 and most preferably at least 75% of all fatty acid components in the ethoxylated sorbitan ester are C18.

Preferably, at least 50% wt. of the ethoxylated sorbitan ester is tetra-ester or hexa-ester. More preferably at least 80% wt. of the ethoxylated sorbitan ester is tetra-ester or hexa-ester.

Preferably, at least 50% wt. of the ethoxylated sorbitan ester is tetra- or hexa-ester-oleate. More preferably at least 80% wt. of the ethoxylated sorbitan ester is tetra-, or hexa-oleate.

Preferably, less than 20% wt. of the ethoxylated sorbitan ester is mono- to tri-ester. More preferably less than 10% wt. of the ethoxylated sorbitan ester is mono-, to tri-ester.

Preferably, less than 20% wt. of the ethoxylated sorbitan ester is tri-stearate. More preferably less than 10% wt. of the ethoxylated sorbitan ester is tri-stearate.

The most preferred ethoxylated sorbitan ester is sorbet trisearate, sorbeth-hexa-oleate or sorbeth tetra oleate. Sorbeth 450 tristearate being a particularly preferred compound.

Where the polyol is pentaerythritol it is preferred that from 20% wt. of all fatty acid components in the ethoxylated pentaerythritol ester are C14-20. More preferably, from 60% of all fatty acid components in the ethoxylated pentaerythritol ester are C14-20 and most preferably at least 90% of all fatty acid components in the ethoxylated pentaerythritol ester are C14-20.

Preferably, from 60% wt. of all fatty acid components in the ethoxylated pentaerythritol ester are C16-18. More preferably, from 75% of all fatty acid components in the ethoxylated pentaerythritol ester are C16-18 and most preferably at least 75% of all fatty acid components in the ethoxylated pentaerythritol ester are C18.

Preferably, at least 50% wt. of the ethoxylated pentaerythritol ester is tetra-ester. More preferably at least 80% wt. of the ethoxylated pentaerythritol ester is tetra-ester.

Preferably, at least 50% wt. of the ethoxylated pentaerythritol ester is tetra-stearate. More preferably at least 80% wt. of the ethoxylated pentaerythritol ester is tetra-stearate.

Preferably, less than 20% wt. of the ethoxylated pentaerythritol ester is mono- or di-ester. More preferably less than 10% wt. of the ethoxylated pentaerythritol ester is mono-, or di-ester.

Preferably, less than 20% wt. of the ethoxylated pentaerythritol ester is mono- or di-stearate. More preferably less than 10% wt. of the ethoxylated pentaerythritol ester is mono- or di-stearate.

The most preferred ethoxylated pentaerythritol ester is pentaerythritol-tetra-stearate.

Where the polyol is glycerol it is preferred that from 20% wt. of all fatty acid components in the ethoxylated glyceryl ester are C14-20. More preferably, from 60% of all fatty acid components in the ethoxylated glyceryl ester are C14-20 and most preferably at least 90% of all fatty acid components in the ethoxylated glyceryl ester are C14-20.

Preferably, at least 50% wt. of the ethoxylated glyceryl ester is tri-ester or tetra-ester. More preferably at least 80% wt. of the ethoxylated glyceryl ester is tri-ester or tetra-ester.

Preferably, at least 50% wt. of the ethoxylated glyceryl ester is tri- or tetra-oleate. More preferably at least 80% wt. of the ethoxylated glyceryl ester is tri-, or tetra-oleate.

Preferably, less than 20% wt. of the ethoxylated glyceryl ester is mono-ester. More preferably less than 10% wt. of the ethoxylated glyceryl ester is mono-ester.

The most preferred ethoxylated glyceryl ester is glyceryl tri-oleate or glyceryl tetra oleate.

Preferably the ethoxylated polyol ester is present at from 0.01-8.0% of the premix composition. More preferably the ethoxylated polyol ester is present at from 1.5 to 5.0% of the premix composition.

Preferred ethyoxylated polyol esters include 40-50% PEG/PPG-120/10 trimethylolpropane trioleate; lauroyl polyoxyl-6 glycerides/hydrogenated palm/palm kernel oil PEG-6 esters; PEG-150 pentaerythrityl tetrastearate, PEG-150 pentaerithrityl tetrastearate; PEG-20 glyceryl tristearate, PEG-20 glyceryl triisostearate, PEG-10 glyceryl trioleate, PEG-40 glyceryl trioleate, PEG-60 glyceryl trioleate; sorbeth-230 tetraoleate; and PEG-120 methyl glucose trioleate, PEG-120 methyl glucose tioleate.

Commercially available ethoxylated polyol esters include Oxiflow range, e.g. F1700 and S6800 (ex. Oxiteno), SorbiThix L-100 (ex. Applechem), Versathis MBAL-LQ (ex. Croda), Labrafil M2130 CS (ex. Gattefosse), Sorbax PTO-20 (ex. PCC), Atlas G1096 (ex. Croda), Arylpon TT (ex. BASF), SP Crothix MBAL LQ (ex. Croda), Examlex GWS 320, GWIS 320, GWO 320, GWO 340, GWO 360 (all exc. Nihon Emulsions), and Novethix HC220 (ex. Lubrizol).

Preferably, the concentrated laundry composition premix comprises 0.1 to 6% wt. salt, more preferably from 1 to 4% wt. salt. The salt is preferably sodium chloride.

The level of salt is selected to provide the appropriate viscosity profile on dilution and so depends on the amount of water used in the dilution step. The preferred level of salt in the final diluted stable laundry liquid composition is from 0.2 to 2% wt. of the composition.

### Liquid Laundry Detergents

The term “laundry detergent” in the context of this invention denotes formulated compositions intended for and capable of wetting and cleaning domestic laundry such as clothing, linens and other household textiles. The object of the invention is to provide a premix which on dilution is capable of forming a liquid laundry detergent composition and in the manner now described.

The term “linen” is often used to describe certain types of laundry items including bed sheets, pillow cases, towels, tablecloths, table napkins and uniforms. Textiles can include woven fabrics, non-woven fabrics, and knitted fabrics; and can include natural or synthetic fibres such as silk fibres, linen fibres, cotton fibres, polyester fibres, polyamide fibres such as nylon, acrylic fibres, acetate fibres, and blends thereof including cotton and polyester blends.

Examples of liquid laundry detergents include heavy-duty liquid laundry detergents for use in the wash cycle of automatic washing machines, as well as liquid fine wash and liquid colour care detergents such as those suitable for washing delicate garments (e.g. those made of silk or wool) either by hand or in the wash cycle of automatic washing machines.

The term “liquid” in the context of this invention denotes that a continuous phase or predominant part of the composition is liquid and that the composition is flowable at 15° C. and above. Accordingly, the term “liquid” may encompass emulsions, suspensions, and compositions having flowable yet stiffer consistency, known as gels or pastes. The viscosity of the composition may suitably range from about 200 to about 10,000 mPa·s at 25° C. at a shear rate of 21 sec-1. This shear rate is the shear rate that is usually exerted on the liquid when poured from a bottle. Pourable liquid detergent compositions generally have a viscosity of from 200 to 1,500 mPa·s, preferably from 200 to 700 mPa·s. Preferably, the viscosity of the premix is from 100 to 300 cps and the viscosity of the diluted composition is from 400-600 cps.

A composition premix according to the invention and also diluted composition may suitably have an aqueous continuous phase. By “aqueous continuous phase” is meant a continuous phase which has water as its basis.

The premix composition of the invention suitably comprises from 5 to 70%, preferably from 15 to 60%, and more preferably from 25 to 50% (by weight based on the total weight of the composition) of one or more detersive surfactants selected from non-soap anionic surfactants, nonionic surfactants and mixtures thereof.

The term “detersive surfactant” in the context of this invention denotes a surfactant which provides a detersive (i.e. cleaning) effect to laundry treated as part of a domestic laundering process.

Non-soap anionic surfactants for use in the invention are typically salts of organic sulfates and sulfonates having alkyl radicals containing from about 8 to about 22 carbon atoms, the term “alkyl” being used to include the alkyl portion of higher acyl radicals. Examples of such materials include alkyl sulfates, alkyl ether sulfates, alkaryl sulfonates, alpha-olefin sulfonates and mixtures thereof. The alkyl radicals preferably contain from 10 to 18 carbon atoms and may be unsaturated. The alkyl ether sulfates may contain from one to ten ethylene oxide or propylene oxide units per molecule, and preferably contain one to three ethylene oxide units per molecule. The counterion for anionic surfactants is generally an alkali metal such as sodium or potassium; or an ammoniacal counterion such as monoethanolamine, (MEA) diethanolamine (DEA) or triethanolamine (TEA). Mixtures of such counterions may also be employed.

A preferred class of non-soap anionic surfactant for use in the invention includes alkylbenzene sulfonates, particularly linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulfophenyl isomers except for the 1-phenyl isomer. LAS is normally formulated into compositions in acid (i.e. HLAS) form and then at least partially neutralized in-situ.

Some alkyl sulfate surfactant (PAS) may be used, such as non-ethoxylated primary and secondary alkyl sulphates with an alkyl chain length of from 10 to 18.

Mixtures of any of the above described materials may also be used.

In a composition of the invention the total level of anionic surfactant may preferably range from 20 to 50% by weight based on the total weight of the surfactant. However, it is preferred that the level of anionic surfactant is lower than the level of non-ionic surfactant. Preferred ratios between the anionic and non-ionic surfactant are from 1:1 to 1000:1 and more preferably from 1:1.5 to 1:20 (anionic to non-ionic).

Also commonly used in laundry liquid compositions are alkyl ether sulfates having a straight or branched chain alkyl group having 10 to 18, more preferably 12 to 14 carbon atoms and containing an average of 1 to 3EO units per molecule. A preferred example is sodium lauryl ether sulfate (SLES) in which the predominantly C12 lauryl alkyl group has been ethoxylated with an average of 3EO units per molecule. However, we have found that alkyl ether sulphates have a deleterious effect on performance of such compositions for use as premixes as described herein and in such instance it is preferred that the level of any alkyl ether sulphate is from 0 to 10% wt. of the total level of surfactant, more preferably from 0 to 1% wt and most preferably zero.

Preferably, the composition comprises from 20 to 95% wt. non-ionic surfactant based on the total weight of surfactant. Nonionic surfactants for use in the invention are typically polyoxyalkylene compounds, i.e. the reaction product of alkylene oxides (such as ethylene oxide or propylene oxide or mixtures thereof) with starter molecules having a hydrophobic group and a reactive hydrogen atom which is reactive with the alkylene oxide. Such starter molecules include alcohols, acids, amides or alkyl phenols. Where the starter molecule is an alcohol, the reaction product is known as an alcohol alkoxylate. The polyoxyalkylene compounds can have a variety of block and heteric (random) structures. For example, they can comprise a single block of alkylene oxide, or they can be diblock alkoxylates or triblock alkoxylates. Within the block structures, the blocks can be all ethylene oxide or all propylene oxide, or the blocks can contain a heteric mixture of alkylene oxides. Examples of such materials include C₈ to C₂₂ alkyl phenol ethoxylates with an average of from 5 to 25 moles of ethylene oxide per mole of alkyl phenol; and aliphatic alcohol ethoxylates such as C₈ to C₁₈ primary or secondary linear or branched alcohol ethoxylates with an average of from 2 to 40 moles of ethylene oxide per mole of alcohol.

A preferred class of nonionic surfactant for use in the invention includes aliphatic C₈ to C₁₈, more preferably C₁₂ to C₁₅ primary linear alcohol ethoxylates with an average of from 3 to 20, more preferably from 5 to 10 moles of ethylene oxide per mole of alcohol.

A further class of non-ionic surfactants include the alkyl poly glycosides and rhamnolipids.

Mixtures of any of the above described materials may also be used.

Preferably, the selection and amount of surfactant is such that the premix and the diluted mixture are isotropic in nature.

### Anti-Foam

The concentrated product may also comprise an anti-foam. Anti-foam materials are well known in the art and include silicones and fatty acid.

Preferably, where present, the fatty acid anti-foam is present at from 1.3 to 3.0, more preferably from 1.4 to 2.0% wt. and most preferably from 1.6 to 1.65% wt. of the premix.

Suitable fatty acids in the context of this invention include aliphatic carboxylic acids of formula RCOOH, where R is a linear or branched alkyl or alkenyl chain containing from 6 to 24, more preferably 10 to 22, most preferably from 12 to 18 carbon atoms and 0 or 1 double bond. Preferred examples of such materials include saturated C12-18 fatty acids such as lauric acid, myristic acid, palmitic acid or stearic acid; and fatty acid mixtures in which 50 to 100% (by weight based on the total weight of the mixture) consists of saturated C12-18 fatty acids. Such mixtures may typically be derived from natural fats and/or optionally hydrogenated natural oils (such as coconut oil, palm kernel oil or tallow).

The fatty acids may be present in the form of their sodium, potassium or ammonium salts and/or in the form of soluble salts of organic bases, such as mono-, di- or triethanolamine.

Mixtures of any of the above described materials may also be used.

For formula accounting purposes, in the formulation, fatty acids and/or their salts (as defined above) are not included in the level of surfactant or in the level of builder.

### Cosurfactants

A composition of the invention may contain one or more cosurfactants (such as amphoteric (zwitterionic) and/or cationic surfactants) in addition to the non-soap anionic and/or nonionic detersive surfactants described above.

Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5% (by weight based on the total weight of the premix composition).

Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms, the term “alkyl” being used to include the alkyl portion of higher acyl radicals. Amphoteric (zwitterionic) surfactant, when included, may be present in an amount ranging from 0.1 to 5% (by weight based on the total weight of the composition).

Mixtures of any of the above described materials may also be used.

Preferably, the composition comprises PEG ester fatty acid. PEG fatty acid ester is included top modify the rheological performance of the composition particularly during dilution. Preferred PEG ester fatty acids include PEG 9 cocoate, PEG 32 and PEG 175.

Preferably, the PEG ester fatty acid is present at from 0.01-5.0% of the premix composition.

### Builders

Preferably, the composition comprises a builder and more preferably this builder is MGDA. We have surprisingly found that the MGDA provides a wider formulation window for this unusual product format and permits more anti-foam without diminishing the visual appeal, in particular the clarity, of the product before dilution by the consumer. This is particularly the case when the composition also comprises a fatty acid anti-foam.

Where present, the MGDA is present at from 0.1 to 3% wt. of the premix composition, preferably from 0.1 to 2 and more preferably from 0.2 to 1.0% wt. of the premix composition. Preferably, the premix composition comprises less than 1% by weight HEDP sequestrant, more preferably less than 0.1% wt. HEDP sequestrant.

While the composition of the invention may comprise MGDA, it is preferred that no other builder is present. Accordingly, compositions of the invention may contain from 0 to 1%, more preferably from 0 to 0.1% wt. premix one or more additional builders.

### Polymeric Cleaning Boosters

To further improve the environmental profile of liquid laundry detergents it may be preferred in some cases to reduce the volume of laundry detergent dosed per wash-load and to add various highly weight efficient ingredients to the composition to boost cleaning performance. In addition to the soil release polymers of the invention described above, a composition of the invention will preferably contain one or more additional polymeric cleaning boosters such as anti-redeposition polymers.

Anti-redeposition polymers stabilise the soil in the wash solution thus preventing redeposition of the soil. Suitable soil release polymers for use in the invention include alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone.

Mixtures of any of the above described materials may also be used.

When included, a premix composition of the invention will preferably comprise from 0.025 to 8% wt. premix such materials depending on the parts premix are intended to be mixed with water. An amount that provides from 0.5 to 6% (by weight based on the total weight of the diluted composition) of one or more anti-redeposition polymers such as, for example, the alkoxylated polyethyleneimines which are described above.

### Soil Release Polymers

Soil release polymers help to improve the detachment of soils from fabric by modifying the fabric surface during washing. The adsorption of a SRP over the fabric surface is promoted by an affinity between the chemical structure of the SRP and the target fibre.

SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred SRPs for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

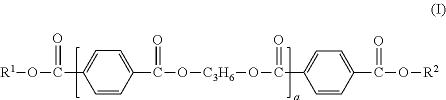

in which R¹ and R² independently of one another are X—(OC₂H₄)ₙ—(OC₃H₆)ₘ;
in which X is C₁₋₄ alkyl and preferably methyl;
n is a number from 12 to 120, preferably from 40 to 50;
m is a number from 1 to 10, preferably from 1 to 7; and
a is a number from 4 to 9.

Because they are averages, m, n and a are not necessarily whole numbers for the polymer in bulk.

Mixtures of any of the above described materials may also be used.

The overall level of SRP, when included, may range from 0.1 to 10%, depending on the level of polymer intended for use in the final diluted composition and which is desirably from 0.3 to 7%, more preferably from 0.5 to 5% (by weight based on the total weight of the diluted composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid laundry detergent premix compositions herein in concentrations ranging from 0.01 percent to 10 percent, more preferably from 0.1 percent to 5 percent, by weight of the premix composition.

### Polymeric Thickeners

A composition of the invention may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁-C₄ alkyl (meth)acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units.

Mixtures of any of the above described materials may also be used.

When included, a composition of the invention will preferably comprise from 0.01 to 5% wt. of the premix but depending on the amount intended for use in the final diluted product and which is desirably from 0.1 to 3% wt. by weight based on the total weight of the diluted composition.

### Fluorescent Agents

It may be advantageous to include fluorescer in the compositions. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.5 wt % the premix.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra, Tinopal 5BMGX, and Blankophor (Trade Mark) HRH, and Pyrazoline compounds, e.g. Blankophor SN.

Preferred fluorescers are: sodium 2 (4-styryl-3-sulfophenyl)-2H-napthol[1,2-d]triazole, disodium 4,4′-bis {[(4-anilino-6-(N methyl-N-2 hydroxyethyl)amino 1,3,5-triazin-2-yl)]amino}stilbene-2-2′ disulfonate, disodium 4,4′-bis {[(4-anilino-6-morpholino-1,3,5-triazin-2-yl)]amino}stilbene-2-2′ disulfonate, and disodium 4,4′-bis(2-sulfoslyryl) biphenyl.

### Shading Dyes

Shading dye can be used to improve the performance of the compositions. Preferred dyes are violet or blue. Preferably the dye is present at 0.000001 to 1 wt % more preferably 0.00001 wt % to 0.0010 wt % of the premix.

Preferably, the dye is selected from direct dyes, acid dyes, hydrophobic dyes, basic dyes, reactive dyes, dye conjugates and mixtures thereof.

### External Structurants

Compositions of the invention may have their rheology further modified by use of one or more external structurants which form a structuring network within the composition. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

### Enzymes

A composition of the invention may comprise an effective amount of one or more enzyme selected from the group comprising, pectate lyase, protease, amylase, cellulase, lipase, mannanase and mixtures thereof. The enzymes are preferably present with corresponding enzyme stabilizers.

### Fragrances

Preferably, the premix comprises a fragrance.

Preferably, the fragrance comprises a component selected from the group consisting of ethyl-2-methyl valerate (manzanate), limonene, (4Z)-cyclopentadec-4-en-1-one, dihyro myrcenol, dimethyl benzyl carbonate acetate, benzyl acetate, spiro[1,3-dioxolane-2,5′-(4′,4′,8′,8′-tetramethyl-hexahydro-3′,9′-methanonaphthalene)], benzyl acetate, Rose Oxide, geraniol, methyl nonyl acetaldehyde, cyclacet (verdyl acetate), cyclamal, beta ionone, hexyl salicylate, tonalid, phenafleur, octahydrotetramethyl acetophenone (OTNE), the benzene, toluene, xylene (BTX) feedstock class such as 2-phenyl ethanol, phenoxanol and mixtures thereof, the cyclododecanone feedstock class, such as habolonolide, the phenolics feedstock class such as hexyl salicylate, the C5 blocks or oxygen containing heterocycle moiety feedstock class such as gamma decalactone, methyl dihydrojasmonate and mixtures thereof, the terpenes feedstock class such as dihydromycernol, linalool, terpinolene, camphor, citronellol and mixtures thereof, the alkyl alcohols feedstock class such as ethyl-2-methylbutyrate, the diacids feedstock class such as ethylene brassylate, and mixtures of these components.

Preferably, the fragrance comprises from 0.5 to 30% wt., more preferably from 2 to 15 wt. % and especially preferably from 6 to 10% wt. of the fragrance ethyl-2-methyl valerate (manzanate).

Preferably, the fragrance comprises from 0.5 to 30% wt., more preferably from 2 to 15% and especially preferably from 6 to 10% wt. of the fragrance (4Z)-cyclopentadec-4-en-1-one.

Preferably, the fragrance comprises from 0.5 to 30% wt., more preferably from 2 to 15% and especially preferably from 6 to 10% wt. of the fragrance dimethyl benzyl carbonate acetate.

Preferably, the fragrance comprises from 0.5 to 30% wt., more preferably from 2 to 15% and especially preferably from 6 to 10% wt. of the fragrance dihyromyrcenol.

Preferably, the fragrance comprises from 0.5 to 30% wt., more preferably from 2 to 15% and especially preferably from 6 to 10% wt. of the fragrance rose oxide.

Preferably, the fragrance comprises from 0.5 to 30% wt., more preferably from 2 to 15% and especially preferably from 6 to 10% wt. of the fragrance verdyl acetate.

Preferably, the fragrance comprises from 0.5 to 30% wt., more preferably from 2 to 15% and especially preferably from 6 to 10% wt. of the fragrance benzyl acetate.

Preferably, the fragrance comprises from 0.5 to 30% wt., more preferably from 2 to 15% and especially preferably from 6 to 10% wt. of the fragrance spiro[1,3-dioxolane-2,5′-(4′,4′,8′,8′-tetramethyl-hexahydro-3′,9′-methanonaphthalene)].

Preferably, the fragrance comprises from 0.5 to 30% wt., more preferably from 2 to 15% and especially preferably from 6 to 10% wt. of the fragrance geraniol.

Preferably, the fragrance comprises from 0.5 to 30% wt., more preferably from 2 to 15% and especially preferably from 6 to 10% wt. of the fragrance methyl nonyl acetaldehyde.

Preferably, the fragrance comprises from 0.5 to 30% wt., more preferably from 2 to 15% and especially preferably from 6 to 10% wt. of the fragrance cyclacet (verdyl acetate).

Preferably, the fragrance comprises from 0.5 to 30% wt., more preferably from 2 to 15% and especially preferably from 6 to 10% wt. of the fragrance cyclamal.

Preferably, the fragrance comprises from 0.5 to 30% wt., more preferably from 2 to 15 wt. % and especially preferably from 6 to 10% wt. of the fragrance beta ionone.

Preferably, the fragrance comprises from 0.5 to 30% wt., more preferably from 2 to 15 wt. % and especially preferably from 6 to 10% wt. of the fragrance hexyl salicylate.

Preferably, the fragrance comprises from 0.5 to 30% wt., more preferably from 2 to 15 wt. % and especially preferably from 6 to 10% wt. of the fragrance tonalid.

Preferably, the fragrance comprises from 0.5 to 30% wt., more preferably from 2 to 15 wt. % and especially preferably from 6 to 10% wt. of the fragrance phenafleur.

Preferably, the fragrance comprises a component selected from the benzene, toluene, xylene (BTX) feedstock class. More preferably, the fragrance component is selected from 2-phenyl ethanol, phenoxanol and mixtures thereof.

Preferably, the fragrance comprises a component selected from the cyclododecanone feedstock class. More preferably, the fragrance component is habolonolide.

Preferably, the fragrance comprises a component selected from the phenolics feedstock class. More preferably, the fragrance component is hexyl salicylate.

Preferably, the fragrance comprises a component selected from the C5 blocks or oxygen containing heterocycle moiety feedstock class. More preferably, the fragrance component is selected from gamma decalactone, methyl dihydrojasmonate and mixtures thereof.

Preferably, the fragrance comprises a component selected from the terpenes feedstock class. More preferably, the fragrance component is selected from, linalool, terpinolene, camphor, citronellol and mixtures thereof.

Preferably, the fragrance comprises a component selected from the alkyl alcohols feedstock class. More preferably, the fragrance component is ethyl-2-methylbutyrate.

Preferably, the fragrance comprises a component selected from the diacids feedstock class. More preferably, the fragrance component is ethylene brassylate.

Preferably, the fragrance comprises from 0.5 to 30% wt., more preferably from 2 to 15 wt. % and especially preferably from 6 to 10% wt. of the octahydrotetramethyl acetophenone (OTNE). OTNE is the abbreviation for the fragrance material with CAS numbers 68155-66-8, 54464-57-2 and 68155-67-9 and EC List number 915-730-3. Preferably the OTNE is present as a multi-constituent isomer mixture containing:
1-(1,2,3,4,5,6,7,8-octahydro-2,3,8,8-tetramethyl-2-naphthyl) ethan-1-one (CAS 54464-57-2)
1-(1,2,3,5,6,7,8,8a-octahydro-2,3,8,8-tetramethyl-2-naphthyl) ethan-1-one (CAS 68155-66-8)
1-(1,2,3,4,6,7,8,8a-octahydro-2,3,8,8-tetramethyl-2-naphthyl) ethan-1-one (CAS 68155-67-9) Such OTNE and its method for manufacture is described fully in U.S. Pat. No. 3,907,321 (IFF).

The fragrance Molecule 01 is a specific isomer of OTNE, commercially available from IFF. Another commercially available fragrance Escentric 01 contains OTNE but also ambroxan, pink pepper, green lime with balsamic notes like benzoin mastic and incense.

Typically, commercially available fragrance raw materials comprise from 1 to 8% wt. of the fragrance raw material OTNE.

Preferably, the fragrance component listed above is present in the final detergent composition at from 0.0001 to 1% by wt. of the composition.

### Microcapsules

One type of microparticle suitable for use in the invention is a microcapsule. Microencapsulation may be defined as the process of surrounding or enveloping one substance within another substance on a very small scale, yielding capsules ranging from less than one micron to several hundred microns in size. The material that is encapsulated may be called the core, the active ingredient or agent, fill, payload, nucleus, or internal phase. The material encapsulating the core may be referred to as the coating, membrane, shell, or wall material.

Microcapsules typically have at least one generally spherical continuous shell surrounding the core. The shell may contain pores, vacancies or interstitial openings depending on the materials and encapsulation techniques employed. Multiple shells may be made of the same or different encapsulating materials, and may be arranged in strata of varying thicknesses around the core. Alternatively, the microcapsules may be asymmetrically and variably shaped with a quantity of smaller droplets of core material embedded throughout the microcapsule.

The shell may have a barrier function protecting the core material from the environment external to the microcapsule, but it may also act as a means of modulating the release of core materials such as fragrance. Thus, a shell may be water soluble or water swellable and fragrance release may be actuated in response to exposure of the microcapsules to a moist environment. Similarly, if a shell is temperature sensitive, a microcapsule might release fragrance in response to elevated temperatures. Microcapsules may also release fragrance in response to shear forces applied to the surface of the microcapsules.

A preferred type of polymeric microparticle suitable for use in the invention is a polymeric core-shell microcapsule in which at least one generally spherical continuous shell of polymeric material surrounds a core containing the fragrance formulation (f2). The shell will typically comprise at most 20% by weight based on the total weight of the microcapsule. The fragrance formulation (f2) will typically comprise from about 10 to about 60% and preferably from about 20 to about 40% by weight based on the total weight of the microcapsule. The amount of fragrance (f2) may be measured by taking a slurry of the microcapsules, extracting into ethanol and measuring by liquid chromatography.

Polymeric core-shell microcapsules for use in the invention may be prepared using methods known to those skilled in the art such as coacervation, interfacial polymerization, and polycondensation.

The process of coacervation typically involves encapsulation of a generally water-insoluble core material by the precipitation of colloidal material(s) onto the surface of droplets of the material. Coacervation may be simple e.g. using one colloid such as gelatin, or complex where two or possibly more colloids of opposite charge, such as gelatin and gum arabic or gelatin and carboxymethyl cellulose, are used under carefully controlled conditions of pH, temperature and concentration.

Interfacial polymerisation typically proceeds with the formation of a fine dispersion of oil droplets (the oil droplets containing the core material) in an aqueous continuous phase. The dispersed droplets form the core of the future microcapsule and the dimensions of the dispersed droplets directly determine the size of the subsequent microcapsules. Microcapsule shell-forming materials (monomers or oligomers) are contained in both the dispersed phase (oil droplets) and the aqueous continuous phase and they react together at the phase interface to build a polymeric wall around the oil droplets thereby to encapsulate the droplets and form core-shell microcapsules. An example of a core-shell microcapsule produced by this method is a polyurea microcapsule with a shell formed by reaction of diisocyanates or polyisocyanates with diamines or polyamines.

Polycondensation involves forming a dispersion or emulsion of the core material in an aqueous solution of precondensate of polymeric materials under appropriate conditions of agitation to produce capsules of a desired size, and adjusting the reaction conditions to cause condensation of the precondensate by acid catalysis, resulting in the condensate separating from solution and surrounding the dispersed core material to produce a coherent film and the desired microcapsules. An example of a core-shell microcapsule produced by this method is an aminoplast microcapsule with a shell formed from the polycondensation product of melamine (2,4,6-triamino-1,3,5-triazine) or urea with formaldehyde. Suitable cross-linking agents (e.g. toluene diisocyanate, divinyl benzene, butanediol diacrylate) may also be used and secondary wall polymers may also be used as appropriate, e.g. anhydrides and their derivatives, particularly polymers and co-polymers of maleic anhydride.

One example of a preferred polymeric core-shell microcapsule for use in the invention is an aminoplast microcapsule with an aminoplast shell surrounding a core containing the fragrance formulation (f2). More preferably such an aminoplast shell is formed from the polycondensation product of melamine with formaldehyde.

Polymeric microparticles suitable for use in the invention will generally have an average particle size between 100 nanometers and 50 microns. Particles larger than this are entering the visible range.

Examples of particles in the sub-micron range include latexes and mini-emulsions with a typical size range of 100 to 600 nanometers. The preferred particle size range is in the micron range. Examples of particles in the micron range include polymeric core-shell microcapsules (such as those further described above) with a typical size range of 1 to 50 microns, preferably 5 to 30 microns. The average particle size can be determined by light scattering using a Malvern Mastersizer with the average particle size being taken as the median particle size D (0.5) value. The particle size distribution can be narrow, broad or multimodal. If necessary, the microcapsules as initially produced may be filtered or screened to produce a product of greater size uniformity.

Polymeric microparticles suitable for use in the invention may be provided with a deposition aid at the outer surface of the microparticle. Deposition aids serve to modify the properties of the exterior of the microparticle, for example to make the microparticle more substantive to a desired substrate. Desired substrates include cellulosics (including cotton) and polyesters (including those employed in the manufacture of polyester fabrics).

The deposition aid may suitably be provided at the outer surface of the microparticle by means of covalent bonding, entanglement or strong adsorption. Examples include polymeric core-shell microcapsules (such as those further described above) in which a deposition aid is attached to the outside of the shell, preferably by means of covalent bonding. While it is preferred that the deposition aid is attached directly to the outside of the shell, it may also be attached via a linking species.

Deposition aids for use in the invention may suitably be selected from polysaccharides having an affinity for cellulose. Such polysaccharides may be naturally occurring or synthetic and may have an intrinsic affinity for cellulose or may have been derivatised or otherwise modified to have an affinity for cellulose. Suitable polysaccharides have a 1-4 linked β glycan (generalised sugar) backbone structure with at least 4, and preferably at least 10 backbone residues which are β1-4 linked, such as a glucan backbone (consisting of (1-4 linked glucose residues), a mannan backbone (consisting of β1-4 linked mannose residues) or a xylan backbone (consisting of (1-4 linked xylose residues).

Examples of such β1-4 linked polysaccharides include xyloglucans, glucomannans, mannans, galactomannans, β(1-3), (1-4) glucan and the xylan family incorporating glucurono-, arabino- and glucuronoarabinoxylans. Preferred β1-4 linked polysaccharides for use in the invention may be selected from xyloglucans of plant origin, such as pea xyloglucan and tamarind seed xyloglucan (TXG) (which has a β1-4 linked glucan backbone with side chains of α-D xylopyranose and β-D-galactopyranosyl-(1-2)-α-D-xylo-pyranose, both 1-6 linked to the backbone); and galactomannans of plant origin such as locust bean gum (LBG) (which has a mannan backbone of β1-4 linked mannose residues, with single unit galactose side chains linked α1-6 to the backbone).

Also suitable are polysaccharides which may gain an affinity for cellulose upon hydrolysis, such as cellulose mono-acetate; or modified polysaccharides with an affinity for cellulose such as hydroxypropyl cellulose, hydroxypropyl methylcellulose, hydroxyethyl methylcellulose, hydroxypropyl guar, hydroxyethyl ethylcellulose and methylcellulose.

Deposition aids for use in the invention may also be selected from phthalate containing polymers having an affinity for polyester. Such phthalate containing polymers may have one or more nonionic hydrophilic segments comprising oxyalkylene groups (such as oxyethylene, polyoxyethylene, oxypropylene or polyoxypropylene groups), and one or more hydrophobic segments comprising terephthalate groups. Typically, the oxyalkylene groups will have a degree of polymerization of from 1 to about 400, preferably from 100 to about 350, more preferably from 200 to about 300. A suitable example of a phthalate containing polymer of this type is a copolymer having random blocks of ethylene terephthalate and polyethylene oxide terephthalate.

Mixtures of any of the above described materials may also be suitable.

Deposition aids for use in the invention will generally have a weight average molecular weight (M_{w}) in the range of from about 5 kDa to about 500 kDa, preferably from about 10 kDa to about 500 kDa and more preferably from about 20 kDa to about 300 kDa.

One example of a particularly preferred polymeric core-shell microcapsule for use in the invention is an aminoplast microcapsule with a shell formed by the polycondensation of melamine with formaldehyde; surrounding a core containing the fragrance formulation (f2); in which a deposition aid is attached to the outside of the shell by means of covalent bonding. The preferred deposition aid is selected from β1-4 linked polysaccharides, and in particular the xyloglucans of plant origin, as are further described above.

The present inventors have surprisingly observed that it is possible to reduce the total level of fragrance included in the composition of the invention without sacrificing the overall fragrance experience delivered to the consumer at key stages in the laundry process. A reduction in the total level of fragrance is advantageous for cost and environmental reasons.

Accordingly, the total amount of fragrance formulation (f1) and fragrance formulation (f2) in the premix of the invention suitably ranges from 0.5 to 1.4%, preferably from 0.5 to 1.2%, more preferably from 0.5 to 1% and most preferably from 0.6 to 0.9% (by weight based on the total weight of the premix).

The weight ratio of fragrance formulation (f1) to fragrance formulation (f2) in the composition of the invention preferably ranges from 60:40 to 45:55. Particularly good results have been obtained at a weight ratio of fragrance formulation (f1) to fragrance formulation (f2) of around 50:50.

The fragrance (f1) and fragrance (f2) are typically incorporated at different stages of formation of the composition of the invention. Typically, the discrete polymeric microparticles (e.g. microcapsules) entrapping fragrance formulation (f2) are added in the form of a slurry to a warmed base formulation comprising other components of the composition (such as surfactants and solvents). Fragrance (f1) is typically post-dosed later after the base formulation has cooled.

### Further Optional Ingredients

A composition of the invention may contain further optional ingredients to enhance performance and/or consumer acceptability. Examples of such ingredients include foam boosting agents, preservatives (e.g. bactericides), polyelectrolytes, anti-shrinking agents, anti-wrinkle agents, anti-oxidants, sunscreens, anti-corrosion agents, drape imparting agents, anti-static agents, ironing aids, colorants, pearlisers and/or opacifiers, and shading dye. Each of these ingredients will be present in an amount effective to accomplish its purpose. Generally, these optional ingredients are included individually at an amount of up to 5% (by weight based on the total weight of the diluted composition) and so adjusted depending on the dilution ratio with water.

Many of the ingredients used in embodiments of the invention may be obtained from so called black carbon sources or a more sustainable green source. The following provides a list of alternative sources for several of these ingredients and how they can be made into raw materials described herein.

### SLES and PAS

SLES and other such alkali metal alkyl ether sulphate anionic surfactants are typically obtainable by sulphating alcohol ethoxylates. These alcohol ethoxylates are typically obtainable by ethoxylating linear alcohols. Similarly, primary alkyl sulphate surfactants (PAS) can be obtained from linear alcohols directly by sulphating the linear alcohol. Accordingly, forming the linear alcohol is a central step in obtaining both PAS and alkali-metal alkyl ether sulphate surfactants.

The linear alcohols which are suitable as an intermediate step in the manufacture of alcohol ethoxylates and therefore anionic surfactants such as sodium lauryl ether sulphate ca be obtained from many different sustainable sources. These include:

### Primary Sugars

Primary sugars are obtained from cane sugar or sugar beet, etc., and may be fermented to form bioethanol. The bioethanol is then dehydrated to form bio-ethylene which then undergoes olefin methathesis to form alkenes. These alkenes are then processed into linear alcohols either by hydroformylation or oxidation.

An alternative process also using primary sugars to form linear alcohols can be used and where the primary sugar undergoes microbial conversion by algae to form triglycerides. These triglycerides are then hydrolysed to linear fatty acids and which are then reduced to form the linear alcohols.

### Biomass

Biomass, for example forestry products, rice husks and straw to name a few may be processed into syngas by gasification. Through a Fischer Tropsch reaction these are processed into alkanes, which in turn are dehydrogenated to form olefins. These olefins may be processed in the same manner as the alkenes described above [primary sugars].

An alternative process turns the same biomass into polysaccharides by steam explosion which may be enzymatically degraded into secondary sugars. These secondary sugars are then fermented to form bioethanol which in turn is dehydrated to form bio-ethylene. This bio-ethylene is then processed into linear alcohols as described above [primary sugars].

### Waste Plastics

Waste plastic is pyrolyzed to form pyrolysed oils. This is then fractioned to form linear alkanes which are dehydrogenated to form alkenes. These alkenes are processed as described above [primary sugars].

Alternatively, the pyrolyzed oils are cracked to form ethylene which is then processed to form the required alkenes by olefin metathesis. These are then processed into linear alcohols as described above [primary sugars].

### Municipal Solid Waste

MSW is turned into syngas by gasification. From syngas it may be processed as described above [primary sugars] or it may be turned into ethanol by enzymatic processes before being dehydrogenated into ethylene. The ethylene may then be turned into linear alcohols by the Ziegler Process.

The MSW may also be turned into pyrolysis oil by gasification and then fractioned to form alkanes. These alkanes are then dehydrogenated to form olefins and then linear alcohols.

### Marine Carbon

There are various carbon sources from marine flora such as seaweed and kelp. From such marine flora the triglycerides can be separated from the source and which is then hydrolysed to form the fatty acids which are reduced to linear alcohols in the usual manner.

Alternatively, the raw material can be separated into polysaccharides which are enzymatically degraded to form secondary sugars. These may be fermented to form bio-ethanol and then processed as described above [Primary Sugars].

### Waste Oils

Waste oils such as used cooking oil can be physically separated into the triglycerides which are split to form linear fatty acids and then linear alcohols as described above.

Alternatively, the used cooking oil may be subjected to the Neste Process whereby the oil is catalytically cracked to form bio-ethylene. This is then processed as described above.

### Methane Capture

Methane capture methods capture methane from landfill sites or from fossil fuel production. The methane may be formed into syngas by gasification. The syngas may be processed as described above whereby the syngas is turned into methanol (Fischer Tropsch reaction) and then olefins before being turned into linear alcohols by hydroformylation oxidation.

Alternatively, the syngas may be turned into alkanes and then olefins by Fischer Tropsch and then dehydrogenation.

### Carbon Capture

Carbon dioxide may be captured by any of a variety of processes which are all well known. The carbon dioxide may be turned into carbon monoxide by a reverse water gas shift reaction and which in turn may be turned into syngas using hydrogen gas in an electrolytic reaction. The syngas is then processed as described above and is either turned into methanol and/or alkanes before being reacted to form olefins.

Alternatively, the captured carbon dioxide is mixed with hydrogen gas before being enzymatically processed to form ethanol. This is a process which has been developed by Lanzatech. From here the ethanol is turned into ethylene and then processed into olefins and then linear alcohols as described above.

### LAS

One of the other main surfactants commonly used in cleaning compositions, in particular laundry compositions is LAS (linear alkyl benzene sulphonate).

The key intermediate compound in the manufacture of LAS is the relevant alkene. These alkenes (olefins) may be produced by any of the methods described above and may be formed from primary sugars, biomass, waste plastic, MSW, carbon capture, methane capture, marine carbon to name a few.

Whereas in the processed described above the olefin is processed to form linear alcohols by hydroformylation and oxidation instead, the olefin is reacted with benzene and then sulphonate to form the LAS.

### Packaging and Dosing

A composition of the invention may be packaged as unit doses in polymeric film soluble in the wash water. Alternatively, a composition of the invention may be supplied in multidose plastics packs with a top or bottom closure. A dosing measure may be supplied with the pack either as a part of the cap or as an integrated system.

A method of laundering fabric using a composition of the invention will usually involve diluting the dose of detergent composition with water to obtain a wash liquor, and washing fabrics with the wash liquor so formed.

In a second aspect there is provided a method for forming a laundry detergent composition by diluting a premix as described above in water.

The consumer may add water to the concentrated premix, or alternatively concentrated premix to the water depending on the preferred consumer behaviour in any particular market. Where the premix is added to water, the premix is made available to the consumer in a regular pack conforming with the volume of the premix purchased. In such instances it is preferred that the packaged premix is available with an appropriately dimensioned dilution container in which water is added from a domestic supply and to which the premix is added to form the functional liquid detergent composition.

Preferably, by diluting said premix 0.8 to 1 to 10 to 1 in water (water to premix). The degree of dilution is also dependent on market choice. In some markets a more concentrated product is desired while in others a more dilute product is preferred. The amount of water instructed to be used is thus variable but it is preferred that the dilution is at least 1:1 and preferably no more than 5 to 1, water to concentrated premix.

In a third aspect there is provided a container comprising a premix as described in the first aspect. Containers include bottles, tottles, sealable bags and doy-packs and such like. Preferably, the container has an orifice which may provide means for adding water from a domestic supply to the container containing a concentrated premix. It is also preferred that the container comprises a means for adding water to the container and a separate means for permitting diluted contents to be dispensed. In such an embodiment the means for adding water is preferably near the top of the container when in a standing disposition and the means for permitting diluted contents to be dispensed is disposed near the bottom in the same disposition.

The container may also be of an expansible type wherein the container as purchased by the consumer is to be expanded before dilution with water from a domestic supply.

For example, the consumer purchases a container which is folded such that it contains a first volume of concentrated premix and is optionally packaged within a secondary package such that the consumer sees only a regular box or carton. Inside such secondary pack is a bag or other such container and which contains the premix. Water is added from a domestic supply and the concentrate is thus diluted to form the liquid laundry treatment composition which can be used in a regular way by the consumer. For example, it may be added to a shuttle device and placed inside a washing machine drum or it may be dispensed into a washing machine drawer.

The water supplied may also be filtered prior to use. This is at the consumer's discretion but it is expected that the concentrated premix described herein is suitable for a wide variety of water hardnesses.

Preferably, the container displaces a volume appropriate to permit dilution of said premix to form a liquid detergent composition at an appropriate dilution. For example, container may have internal volume (V) and the premix supplied in the container may have volume V/3. In such an embodiment the consumer will be directed to add two parts of water to one part of premix such that the volume of diluted premix is substantially equal to V.

In an alternative embodiment the premix is marketed in a container of appropriate size to match the volume sold, together with a ‘keeper’ container which can be sold filled with diluted product or empty as the consumer prefers. The pre-mix container and the keeper container are maintained together by a form of secondary wrapping such as shrink wrap.

The keeper may have a marker assisting the user in achieving the correct dilution levels.

### EXAMPLES

### Example 1

The following are two formulation (1 and 2) according to the invention and is manufactured using standard protocols. These are premix formulations and are intended to be diluted one part premix with five parts water by the consumer.

| | 1 | 2 | 3 | 4 |
|---|---|---|---|---|
| Ingredient | % wt. | % wt. | % wt. | % wt. |
| Water | to 100 | to 100 | to 100 | to 100 |
| Salt | 4 | 4 | 4 | 4 |
| Propylene Glycol | 8 | 10 | 14 | 8 |
| Sodium Hydroxide | 0.4 | 0.4 | 0.4 | 0.4 |
| Fluorescer | 0.18 | 0.18 | 0.18 | 0.18 |
| TEA buffer | 2 | 2 | 2 | 2 |
| LAS Acid | 7.8 | 7.8 | 7.8 | 7.8 |
| Sodium Hydroxide | 0.21 | 0.21 | 0.21 | 0.21 |
| CABP | 3 | 3 | 3 | 3 |
| Non-ionic Surfactant | 31.2 | 31.2 | 31.2 | 31.2 |
| Ethoxylated polyol ester | 5 | 5 | 5 | 5 |
| Soil Release Polymer | 0 | 0.6 | 0.6 | 0.6 |
| EPEI | 0 | 2.25 | 2.25 | 2.25 |
| Dye | 0.02 | 0.02 | 0.02 | 0.02 |
| Phenoxyethanol | 7 | 5 | 0 | 0 |
| Preservative | 0.0095 | 0.0095 | 0.0095 | 0.0095 |
| Enzyme | 0.045 | 0.045 | 0.045 | 0.045 |
| Enzyme | 0.002 | 0.002 | 0.002 | 0.002 |
| Fragrance | 2.28 | 2.28 | 2.28 | 2.28 |

### Example 2

The following is an embodiment process.

Make a pre-mix of optical brighter, water, dye. Separately, prepare a batch of brine, water, MPG, glycerin, TEA, NaOH (60% of total formula quantity).

Then add LAS acid and allow to react for 5 minutes.

Add the remaining (about 40%) of the NaOH to adjust pH for 6.5-7.5 (preferably 6.5 to 7.0).

Add Betaine (55° C.) before adding the non-ionic surfactant and maintaining the temperature of the batch at 45° C.-55° C. Mix for 5 min.

Add pre-heated ethoxylated polyol ester and maintain batch temperature at from 45° C.-55° C.

Cool down to 30° C. by no more than 1° C. per minute.

At 40° C. add preservatives.

Add the premix of optical brighter and dye.

At 30° C. add enzymes.

### Example 3

Formulations 1 to 4 were tested for stability. Formulations 1 and 2 were stable while 3 and 4 were unstable. This indicates that the level of MPG can be dropped so long as the level of POE is raised.

1. A concentrated laundry composition premix which is dilutable in water to form a laundry liquid composition, said premix comprising water, from 5 to 70% wt. surfactant, from 2 to 15% wt. hydrotrope, from 2 to 15% wt. phenoxyethanol and wherein the total hydrotrope and phenoxyethanol is from 13 to 17% wt. of the premix, and wherein the premix has a viscosity measured at 25° C. and at 106 s⁻¹ of from 100 to 800 mPa·s and wherein the viscosity of the stable laundry liquid composition which is formed from a dilution of five parts (vol) water to one part (vol) premix and measured at 25° C. and at 106 s⁻¹ is from 200 to 800 mPa·s, wherein the composition comprises ethoxylated polyol ester, wherein the ethoxylated polyol ester comprises on average at least two ester units per molecule, where the surfactant is selected from non-soap anionic surfactants, nonionic surfactants and mixtures thereof, and wherein the pH of the concentrated laundry composition is from 5 to 9.

2. The concentrated laundry composition premix according to claim 1 further comprising from 6.5 to 8.5% wt. hydrotrope.

3. The concentrated laundry composition premix according to claim 1 further comprising from 6.5 to 8.5% wt. phenoxyethanol.

4. The concentrated laundry composition premix according to claim 1 wherein the polyol is selected from sorbitol, pentaerythritol and glycerol.

5. The concentrated laundry composition premix according to claim 1 wherein the ester is stearate or oleate.

6. (canceled)

7. The concentrated laundry composition premix according to claim 1 wherein the polyol is sorbitol, and the ester is an oleic acid ester.

8. The concentrated laundry composition premix according to claim 1 wherein the premix comprises from 0 to 5% wt. alkyl ether sulphate.

9. The concentrated laundry composition premix according to claim 1 wherein the surfactant comprises anionic surfactant and non-ionic surfactant in a weight ratio of from 50:50 to 1:99 and wherein the composition comprises from 0 to 5% wt. alkyl ether sulphate.

10. (canceled)

11. A method for forming a laundry detergent composition by diluting one part the concentrated laundry composition premix according to claim 1 in from 1 to 10 parts water.
